(19) United States
(12) Patent Application Publication
(10) Pub. No.: US 2004/0173434 A1
(43) Pub. Date: Sep. 9, 2004

(54) Coin-like products, identification method thereof and identification device thereof

(75) Inventors: Shinichi Morita, Osaka (JP); Yoshinori Yama, Osaka (JP); Hideaki Mori, Osaka (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Japan Mint, Osaka-shi (JP)

(21) Appl. No.: 10/754,849

(22) Filed: Jan. 9, 2004

(30) Foreign Application Priority Data
Jan. 9, 2003 (JP) 3648/2003

(51) Int. Cl. G07D 5/08

(52) U.S. Cl. 194/320

(57) ABSTRACT

The present invention provides a new identification method • identification device of a coin-like product, and a coin-like product having a structure for identification that makes the identification method applicable. The coin-like product 1 of the present invention has a laminate structure formed by two or more kinds of metal layers 11 and 12. The first layer 11, which is a surface layer on one plate side of the laminate structure, and the second layer 12, which is a surface layer on the other plate side of the laminate structure, have different electric conductivities, which makes it possible to identify the structure by a reflex electronic sensor. In the identification method and the identification device, a path is formed, through which a coin-like product 1 can pass, reflex electronic sensors 100 and 200 are disposed along the path so that the first layer and the second layer of the coin-like product 1 can come close to the sensors, and identification is performed based on the outputs of each magnetic sensor, which are specific to the metallic materials.

### FIELD OF THE INVENTION

The present invention relates to a coin-like product having a structure permitting identification using a reflex electronic sensor, a method for identifying the coin-like product utilizing the structure and an identification device thereof.

### BACKGROUND OF THE INVENTION

Coin-like products (e.g., coins, play coins etc.) circulate for certain purposes in the society and particular facilities. Where coin-like products are used for certain purposes, a confirmation if the coins are true coin-like products, and when plural kinds of coin-like products are used, an identification of the products becomes necessary.

Where the game coins are used, identification utilizing the shape of a coin slot may be sufficient, but in the case of moneychangers for coins and various coin-operated vending machines, close identification is necessary if the object dropped in is a true coin and what kind of coin it is.

In moneychangers and vending machines, many coin identification devices are repeatedly set to closely identify if the object dropped in is a true coin, and if it is, what kind of coin it is.

The identification method utilized for coin identification devices includes a method based on mechanical or electronic detecting mechanism, an optical or image processing method and the like. According to these identification methods, the coins are identified depending on the characteristic shapes of the coin (shape, outer diameter, thickness, weight, ridges, design etc.), electrical, magnetic characteristics of the material, and various characteristics unique to each kind of coin.

Of the aforementioned identification methods, the electronic identification method is based on the electrical, magnetic properties unique to a metallic material of each coin, and is a useful method that can enhance identifiability of the coin.

Of the electronic sensors, a particularly useful sensor is a magnetic sensor, which is represented by an eddy current loss detection type magnetic sensor.

The eddy current loss detection type magnetic sensor includes a transmission type (opposed-coil type) magnetic sensor (JP-B-2567654) and a reflex type magnetic sensor (JP-A-2000-11229). Both sensors irradiate a magnetic signal, which is generated by an oscillation coil, to the coin and detect changes in the magnetic signal, due to an eddy current loss in the coin, by a receiving coil. Thus, it is called an eddy current loss detection type.

In the description of the prior art and the present invention hereinafter, an eddy current loss detection type magnetic sensor is to be also simply referred to a “magnetic sensor”.

In the transmission type magnetic sensor of JP-B-2567654, an oscillation coil and a receiving coil are disposed to face each other with a coin path interposed between them. When a coin is present between the two coils, an output signal of the receiving coil shows changes specific to the coin material, based on which the coin is identified. A magnetic signal from the oscillation coil passes through the coin and reaches the receiving coil. Due to this structure, this sensor is called a transmission type.

In contrast, the magnetic sensor disclosed in JP-A-2000-11229 has a constitution wherein an exciting coil and a reflex detecting coil are arranged in proximity to each other on the same side relative to the coin to be identified. A magnetic signal from the oscillation coil is reflected by the coin with an eddy current loss and reaches the receiving coil. Due to this structure, this sensor is called a reflex type.

As described in JP-A-2000-11229, a reflex type magnetic sensor preferably improves the defect of a transmission type magnetic sensor, or low clad coin identifiability.

By the above-mentioned clad coin is meant a three-laminate structure coin circulating in foreign countries such as USA. As described in the above-mentioned JP-A-2000-11229, paragraph (0002), “a clad coin means, as one example is shown in FIG. 15, a three-layer laminate structure coin made of different materials wherein aluminum (Al) or copper is used as a core material and white copper (CuNi) is formed on both surfaces”, conventional clad coins comprise the same material for the surface layers on both sides and a different material for the inner layer.

The major reason for making the above-mentioned three-layer laminate structure for a clad coin is said to be that, since silver coins were conventionally circulated and magnetic sensors were already installed for the identification of the silver coins, when preparing a product to take the place of the silver coins, adjustment of the magnetic sensors in the existing vending machines should be avoided by ensuring magnetic properties equivalent to those of the silver coins while using a low cost material, and that the good appearance of the both surfaces of the coins should be retained by the use of the same white copper (CuNi) while dramatically reducing the whole material cost by the low cost of the material used for the middle layer.

As mentioned above, various methods and devices have been developed for the identification of coin-like products. If a new identification method and a device are available in addition to these conventional methods and devices, identification precision of coin-like products can be increased, thereby more effectively removing forged coins.

It is therefore an object of the present invention to provide a new identification method and an identification device for coin-like products, and to impart a new identification structure to coin-like products, which makes the identification method applicable.

### SUMMARY OF THE INVENTION

According to the present invention, a new identification method and an identification device using a reflex type electronic sensor have been provided by imparting a new clad structure to a coin-like product.

That is, the present invention provides the following.

(1) A coin-like product having a laminate structure comprising two or more metal layers,

wherein said metal layers are laminated in a plate thickness direction of the coin-like product, and a first surface layer of the metal layer on one side of the coin-like product and a second surface layer on the other side of the coin-like product are composed of materials having different electric conductivities, which can be identified by a reflex electronic sensor.

(2) The coin-like product of the above-mentioned (1), wherein the material of the first layer and the material of the second layer are both non-magnetic metallic materials.

(3) The coin-like product of the above-mentioned (2), wherein the non-magnetic metallic material is copper or a copper alloy.

(4) The coin-like product of the above-mentioned (1), which has a dissimilar-metal-layout structure comprising at least one pair of parts made of different materials existing in the plate plane extending direction, wherein one or more of the parts has(have) the above-mentioned laminate structure.

(5) The coin-like product of the above-mentioned (4), wherein the parts are made of metal materials having different electric conductivities, which materials can be identified by a reflex electronic sensor.

(6) The coin-like product of the above-mentioned (4), wherein the above-mentioned dissimilar-metal-layout structure comprises different materials for a central part and a peripheral part of the plate.

(7) The coin-like product of the above-mentioned (6), wherein the parts are made of metal materials having different electric conductivities, which materials can be identified by a reflex electronic sensor.

(8) The coin-like product of the above-mentioned (1), wherein the reflex electronic sensor is a reflex type eddy current loss detection type magnetic sensor.

(9) A method for identifying a coin-like product of any of the above-mentioned (1) to (8), which method comprises the steps of

forming a path for the coin-like product to pass through,

disposing reflex electronic sensors along the path in such a manner that at least the first layer and the second layer of the coin-like product passing through the path come in the proximity to the sensors, and

judging whether or not an object that passed through the path is the aforementioned coin-like product having the first layer and the second layer, based on the outputs of the reflex electronic sensors, which are specific to the metallic materials.

(10) The method of the above-mentioned (9), wherein the judgment is based on the following criteria (A):

(A) the absolute value of the difference between the outputs of the reflex electronic sensors on passage of the object through the path is within an admissible range relative to the absolute value of the difference between the outputs of the first layer and the second layer as measured in advance using said sensors.

(11) The identification method of the above-mentioned (9), wherein the coin-like product to be identified has the characteristics defined in the above-mentioned (6) and (7), and the method comprises the steps of

setting reflex electronic sensors along the path in such a manner that the central part and the peripheral part of the both sides of the coin-like product come in the proximity to the sensors, and

judging whether or not the object that passed through the path has a dissimilar-metal-layout structure and whether or not at least one of the peripheral part and the central part is a laminate structure, based on the outputs specific to the metallic materials of the central part and the peripheral part of the both sides.

(12) The identification method of the above-mentioned (11), wherein at least one pair of the reflex electronic sensors are set at positions where the central parts of the both sides of the coin-like product pass, thereby to allow the product to successively come close to the sensors in the order of the peripheral part, the central part and the peripheral part.

(13) The identification method of the above-mentioned (9), wherein the reflex electronic sensor is a reflex type eddy current loss detection type magnetic sensor.

(14) A device for identifying a coin-like product of any of the above-mentioned (1) to (8), which comprises a path where the coin-like product can pass through, reflex electronic sensors along the path, which are disposed in such a manner that at least the first layer and the second layer of the coin-like product passing through the path come in the proximity to the sensors, and a judgment circuit to judge whether or not an object that passed through the path is the aforementioned coin-like product having the first layer and the second layer, based on the output of each of the reflex electronic sensors, which is specific to the metallic material, and to output the judgment result.

(15) The device of the above-mentioned (14), wherein the above-mentioned path is adapted to move the coin-like product in the diameter direction and at least one pair of the reflex electronic sensors are disposed on the both sides of the path.

(16) The device of the above-mentioned (14), wherein the reflex electronic sensor is disposed at the position where the central part of the coin-like product passes.

(17) The device of the above-mentioned (16), wherein the coin-like product to be identified has the characteristics defined in the above-mentioned (6) and (7), and the judgment circuit is so formed to judge whether or not an object that passed through the path is a coin-like product, based on the outputs specific to the metallic materials of the peripheral part, the central part and the peripheral part of the both sides of the object, which the sensors successively provide when the coin-like product passes through a detection area of said sensor.

(18) The device of the above-mentioned (14), wherein the reflex electronic sensor is a reflex type eddy current loss detection type magnetic sensor.

### BRIEF DESCRIPTION OF THE DRAWINGS

FIG. 1 is a schematic view showing one embodiment of the constitution of the coin-like product, the identification method and the identification device of the present invention. The symbols 1, 100 and 200 used in this Figure apply to the same parts in other Figures.

FIG. 2 is a cross sectional view showing an embodiment wherein the coin-like product in the present invention comprises a layered structure and a bi-metal structure in combination.

FIG. 3 is a perspective view showing an embodiment of a path to be formed in the present invention.

FIG. 4 is a perspective view showing another embodiment of a path to be formed in the present invention.

FIG. 5 shows the positions of the reflex electronic sensors used for the identification method and the identification device of the present invention.

### DETAILED DESCRIPTION OF THE INVENTION

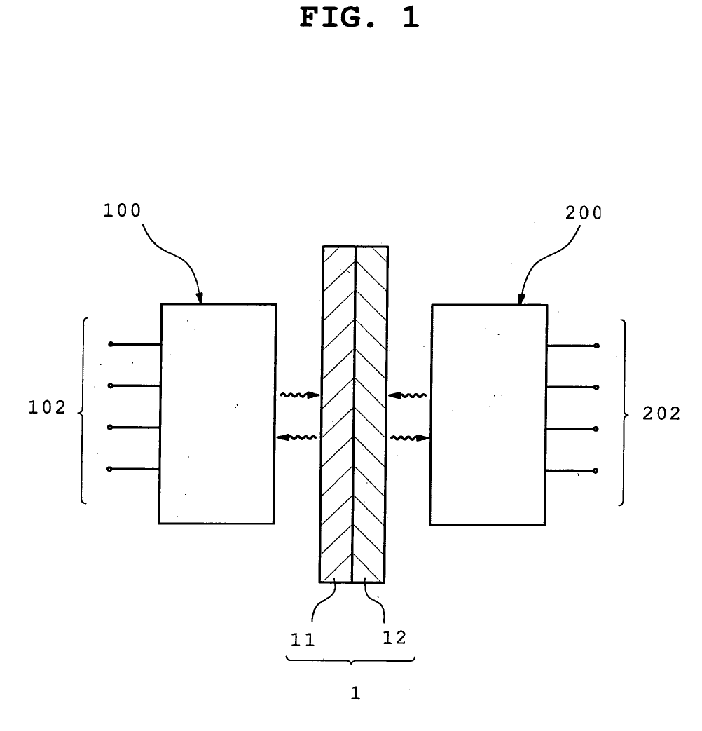

FIG. 1 shows a sectional structure of the coin-like product 1 of the present invention, and is a schematic view showing the identification device of the present invention, wherein reflex electronic sensors 100 and 200 are disposed in such a manner that the both sides of the coin-like product 1 will come in the proximity thereto. With this identification device, the identification method of the present invention becomes practical. In the embodiment of this Figure, a reflex type magnetic sensor is used as a reflex electronic sensor.

In the embodiment of FIG. 1, the coin-like product is a disc and has a thickness as shown of the disc. The concaves and convexes of the relief and a protuberance to be formed on the outer periphery of the coin-like product are omitted.

As shown in the section of FIG. 1, the coin-like product has a laminate structure (clad structure) wherein two or more metal layers are laminated in the direction of plate thickness of the coin-like product. In the embodiment of this Figure, the whole coin-like product 1 is a laminate structure and the laminate structure has a two-layer structure wherein two kinds of metal layers (a first layer 11, a second layer 12) are laminated.

The structural characteristic unique to the present invention is that, of the metal layers constituting the laminate structure, a metallic material of the first layer 11, which is a surface layer of one side of the plate and a metallic material of the second layer 12, which is a surface layer of the other side of the plate, are made from materials having different electric conductivities, which can be identified by a reflex electronic sensor.

As used in the present invention, by the “coin-like product” is meant not only hard currency but also medals. The medal here refers to one intended for use in particular facilities, such as play medals, irrespective of whether the medal has monetary value in such particular facilities. It may be a medal used solely for management purposes, which is used for, for example, counting visitors who dropped, into a device, memorial medals distributed free at the entrance.

In the laminate structure of the coin-like products, a metallic material of the first layer 11 and a metallic material of the second layer 12 may be any as long as they differ from each other to the degree that enables identification of the both by a reflex electronic sensor.

The present invention is explained in the following by referring to a reflex type magnetic sensor as a reflex electronic sensor. The sensor may be a reflex type (proximity type) sensor that can output a signal when the sensor approaches the object, in response to the electrical or electromagnetic characteristics specific to the material.

In the identification using a reflex type magnetic sensor, the electric conductivity of the metallic material becomes an important factor for identification. As a preferable metallic material for identification by a magnetic sensor based on the eddy current loss it shows, non-magnetic materials can be mentioned.

The laminate structure may be any as long as the surface layers on the both sides are the aforementioned first layer and the second layer, and the number of layers laminated is not limited. In addition to the first layer and the second layer, a layer irrelevant to the identification may be contained as an inner layer, and the material of the inner layer may be a known core material of a conventionally known three-layer clad structure.

Each of the first layer and the second layer of the laminate structure may not necessarily have a single layer, but may have a multi-laminate structure. For the identification by a reflex type magnetic sensor, the magnetic properties of each multi-laminate structure as a whole are detected and compared.

When the first layer and/or the second-layer have/has a multi-laminate structure, the surface layers on the both sides may be made from the same material. For example, when the entire surface of a two-layer clad structure consisting of material layer A and material layer B is coated with material C (to make a layer that influences a reflex type magnetic sensor), the whole layer structure becomes (material layer C/material layer A/material layer B/material layer C). In this case, the structure has material layer C on both sides in appearance, but the first layer is (material layer C/material layer A), and the second layer is (material layer C/material layer B) when identified by a reflex electronic sensor, showing magnetic properties different from each other, thus permitting identification. In addition, the first layer or the second layer may share the central layer.

In addition, a coating layer free of influence on the identification by a reflex type magnetic sensor may be formed on the surfaces of the first layer and the second layer. Even if such a coating layer is present on the surface, the first layer and the second layer are considered to be substantial surface layers for identification as long as the subjects of identification for the reflex type magnetic sensor are the first layer and the second layer.

As the material of the first layer and the second layer of the coin-like products, copper and copper alloy are preferable materials because they are superior in appearance, mechanical strength, hardness, corrosion resistance, processability and the like, and are non-magnetic materials that can be identified easily by a reflex type magnetic sensor. The composition of the copper alloy is preferably exemplified by copper-nickel, copper-zinc-nickel, copper-zinc, copper-zinc-tin, copper-aluminum-nickel, copper-aluminum-zinc-tin and the like.

The respective materials of the first layer and the second layer may have various contents of respective components, so that the material can be clearly identified by a reflex type magnetic sensor.

Specific combination of the materials preferable for the surface layer of a coin includes an alloy of Ni 25 wt %-Cu 75 wt % for the first layer and an alloy of Ni 15 wt %-Cu 85 wt % for the second layer, and the like.

The shape of outer periphery, presence or absence of hole, outer diameter and thickness of a coin-like product are not limited and may be determined appropriately in consideration of the identifiability according to its use.

In the case of a coin, a disc having an outer diameter of about 15 mm-30 mm and a thickness of about 1.5 mm-3.0 mm is preferable because it is used in existing vending machines and the like along with other coins, and it can pass smoothly through an identification device.

While the thickness of the first layer and the second layer is not particularly limited, it is preferably not less than 0.5 mm, and in consideration of the entire flow for stamping during concavo-convex processing, the thickness is preferably not less than 0.7 mm.

While the method for lamination to give a laminate structure is not limited, bonding with pressure is a preferable method for forming the first layer and the second layer at the above-mentioned layer thickness, as in the case of formation of a conventionally-known layer structure of a clad coin.

While the whole coin-like product has a laminate structure in the above explanation, it is also possible to introduce a dissimilar-metal-layout structure represented by a bi-metal structure, and make an optional part divided thereby have a laminate structure.

The dissimilar-metal-layout structure comprises plural parts made of different materials arranged in the plate surface extending direction (direction perpendicular to the direction of plate thickness) of a coin-like product. When, metals having dramatically different colors and texture are used on the plate surface of a coin-like product, a visual effect of a wooden mosaic work can be afforded.

In a dissimilar-metal-layout structure, no particular limitation is imposed on the pattern of the parts made of different materials arranged in the plate surface of a coin-like product. For example, the arrangement pattern includes a pattern made by joining two semicircular parts (may be 3 or more fan shape parts) made of different materials to form a disc, a pattern made by placing different materials for the central part and the peripheral part of the plate surface and the like. In the latter case, the peripheral part may be a single area having a donut shape, or the peripheral part may be further divided into plural concentric parts like annual rings as seen in a tri-metal coin (where three kinds of metals are arranged).

Of the dissimilar-metal-layout structures, a bi-metal structure (where two kinds of metals are arranged) has been realized as a structure where different metallic materials are used for the peripheral part and the central part as in, for example, 1 euro coins and 2 euro coins issued by the European Union in 2002. How to join the peripheral part and the central part to give a bi-metal structure can be known from prior art techniques (e.g., JP-A-58-3743, JP-A-8-205912).

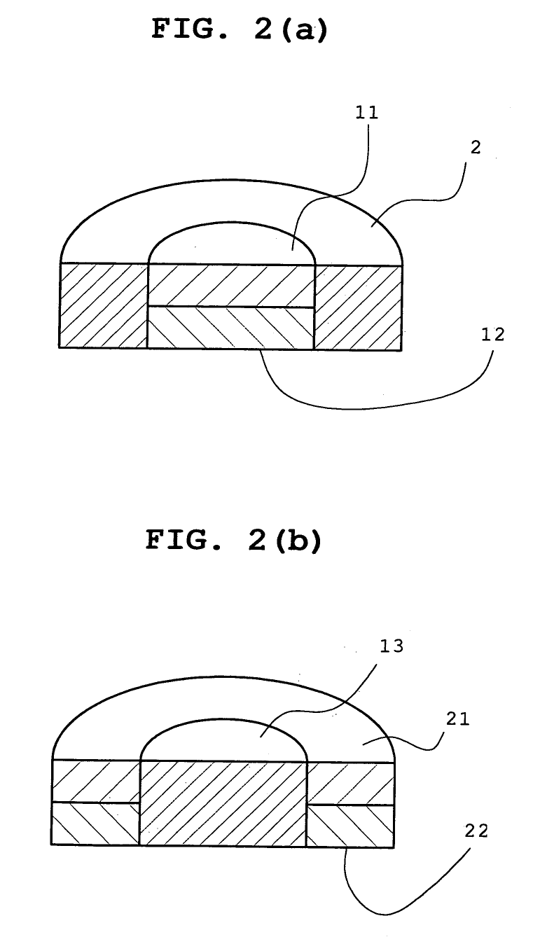

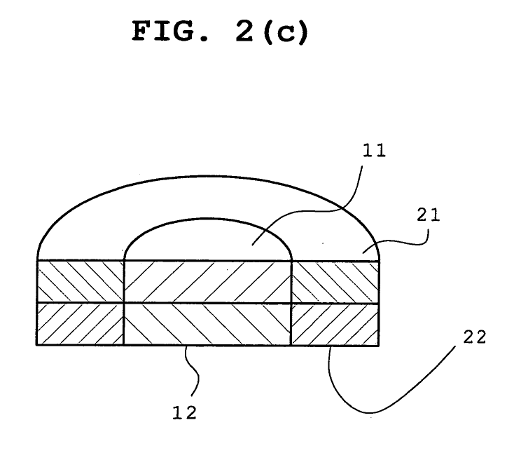

Embodiments of the coin-like product of the present invention having a combination of a layered structure and a dissimilar-metal-layout structure are shown in FIGS. 2(a)-2(c). In the embodiments shown in this Figure, a bi-metal structure is used for the dissimilar-metal-layout structure, wherein the peripheral part and the central part are concentric. The constitution is not limited to the embodiments shown in this Figure, and the pattern of the dissimilar-metal-layout structure of a coin-like product and the location of a laminate structure therein can be freely determined.

In the embodiment of FIG. 2(a), the central part of a bi-metal structure has a laminate structure (the first layer 11, the second layer 12), and the peripheral part 2 is a ring of a single layer.

In the embodiment of FIG. 2(b), conversely from FIG. 2(a), a peripheral part of a bi-metal structure has a laminate structure (the first layer 21, the second layer 22), and the central part 13 is a disc of a single layer.

In the embodiment of FIG. 2(c), both the central part and the peripheral part of a bi-metal structure have laminate structures (central part; the first layer 11, the second layer 12, peripheral part; the first layer 21, the second layer 22).

In any embodiment, the material of the layer can be determined such that the materials that appear on the same side are different between the central part and the peripheral part, thereby achieving an embodiment of a bi-metal structure.

In this case, moreover, the materials of the central part and the peripheral part, which appear on the plane on the same side, may be different only visually. When the central part and the peripheral part, which appear on the plane on the same side, are made from the above-mentioned metallic materials that can be identified by a reflex type electronic sensor (particularly a magnetic sensor), the identifiability of the coin-like product becomes higher. The identification method is described later.

As a method for producing a coin-like product of the embodiment shown in FIG. 2, a conventionally-known production method may be applied. In the embodiment of the bi-metal structure in FIG. 2(a), for example, a central part punched out from a pressure bonded plate is fit into a peripheral part punched out from a single layer plate and pressed to join them. A fit-in structure for avoiding easy release of the two, pressurization method, shapes of both parts before pressurization and the like are described in detail in JP-A-58-3743 and JP-A-8-205912.

In the following, a method for identifying the above-mentioned coin-like products and the constitution of the identification device to practice the method are explained simultaneously. The explanation of the method is directly connected to the constitution of the device, which is its direct realization, and is also an explanation of a device.

As used herein, identifying the coin-like product of the present invention means identification of whether or not the test subject is a coin-like product of the present invention, and when plural kinds of coin-like products of the present invention have been issued, it includes identification of which coin-like product it is.

FIG. 1 is a schematic view showing a basic constitution of the identification device, wherein a coin-like product is being identified using the device (namely, the identification method is being practiced). As shown in this Figure, the constitution of the identification device includes a path (not shown) through which a coin-like product 1 can pass, and reflex type magnetic sensors 100, 200 set on both sides of the path (reflex electronic sensors as in the above). In the case of a reflex type magnetic sensor, an exciting coil and a reflection detection coil (not shown) are set inside each sensor, whereby a magnetic loss specific to the metal can be detected by reflection. In the embodiment shown in this Figure, four input-output wirings 102, 202 are shown per one reflex electronic sensor (magnetic sensor) for easy explanation. This is a mere example and does not limit the number of individual wirings.

The reflex electronic sensors 100, 200 may not be placed at exactly opposing positions, but at least one pair of the reflex electronic sensors are disposed at such positions that make the first layer 11 and the second layer 12 of a coin-like product 1 passing through the path come in the proximity thereto.

When the coin-like product passes through the path, the reflex electronic sensor 100 provides the output unique to the metallic material of the layer on one side (the first layer 11) and reflex electronic sensor 200 provides the output unique to the metallic material of the layer on the other side (the second layer 12). When two sides of a coin-like product dropped are reversed, the outputs of each sensor become also reversed. However, when the coin-like product is a true one, the combination of the outputs remains always the same. According to the identification method, whether or not an object that passed through the path belongs to the aforementioned coin-like product having the first layer and the second layer is identified based on the outputs. To automatically perform the identification, a judgment circuit is so made that the identification device compares the outputs of the reflex electronic sensor with the criteria outputs to be originally output, and automatically determines if an object that passed through the path is one of the aforementioned coin-like products, and provides the determination result.

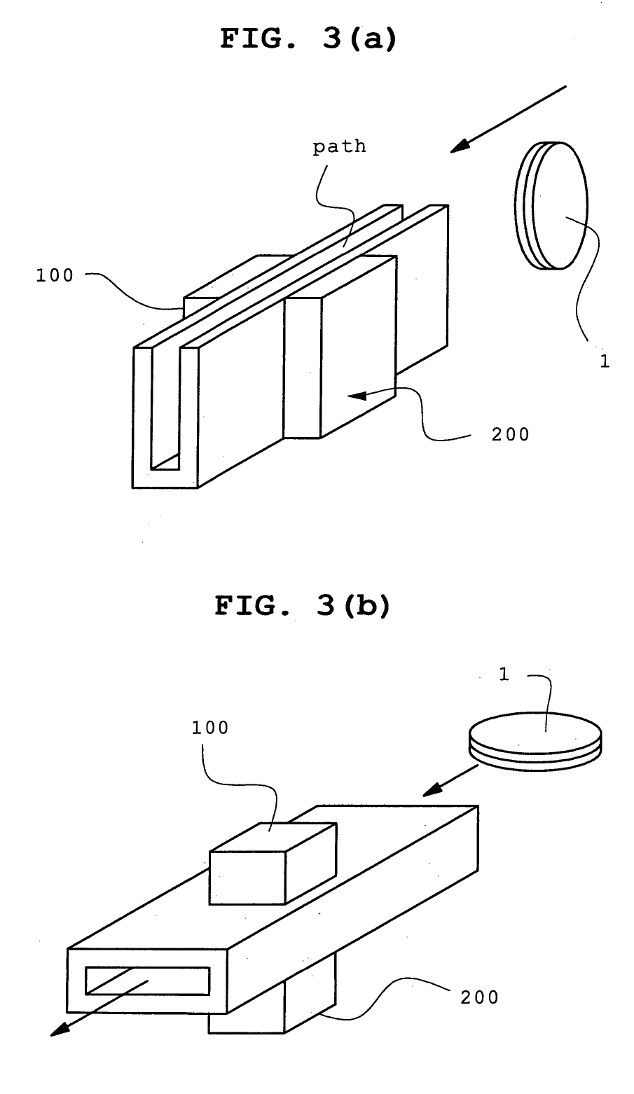

While the embodiment of the path is free of any limitation, it is preferable to form a slot-like path as shown in FIG. 3, so that the both sides of a coin-like product can come in proximity to a reflex electronic sensor and all coin-like products can pass in the same and constant attitude.

The path shown in FIG. 3(a) has a vertical slot, wherein a coin-like product rolls in the diameter direction while standing up or passes as if sliding. The path shown in FIG. 3(b) has a horizontal slot, wherein a coin-like product passes while lying horizontally.

However, the constitution of the path is not limited to those mentioned above, and the path may move a coin-like product in the direction of the normal line of the plate surface.

These embodiments of the path can be appropriately determined according to the devices, such as vending machine and the like in which the identification device is incorporated.

It is also possible to make the path head downward or in the vertical direction, thereby to facilitate passage of a coin-like product therethrough, or utilize gravity to allow a coin-like product to advance due to its own weight, or to forcibly move a coin-like product by a delivery belt or a pushing device.

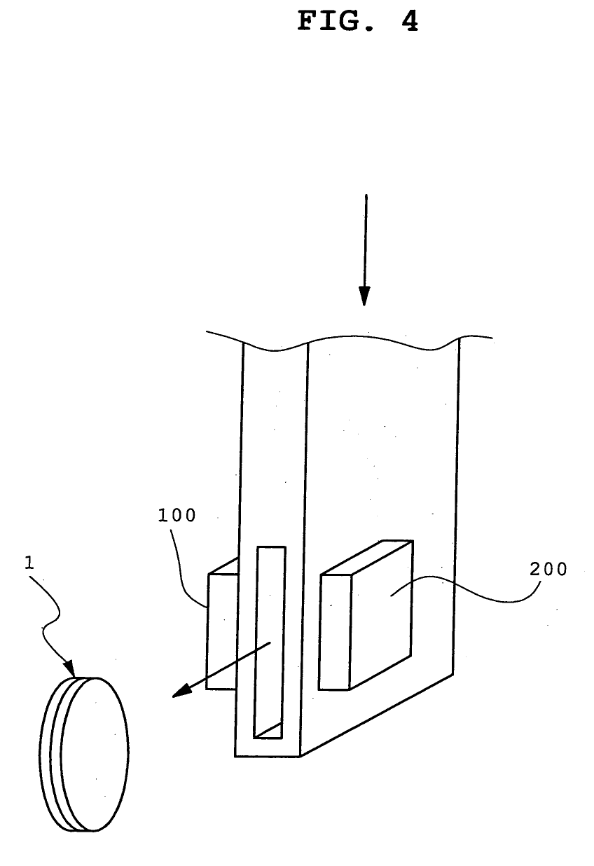

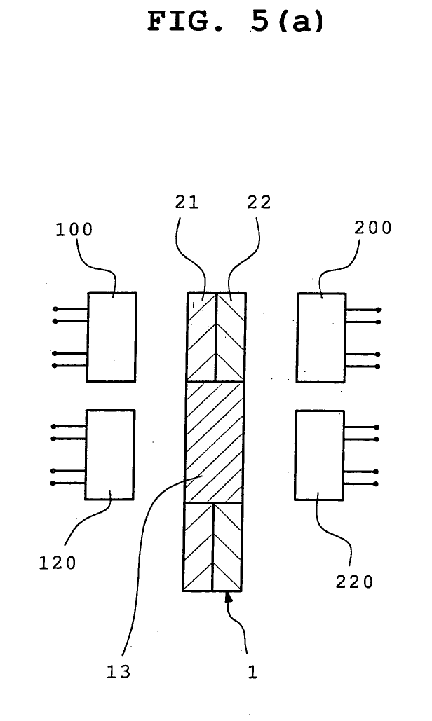

In the embodiment of FIG. 3, reflex electronic sensors are set on the way of a long straight path, and the sensors read changes on the output in the instant the coin-like product crosses the reflex electronic sensor. The constitution is not limited to those shown in FIG. 3. As shown in the embodiment of FIG. 4, a coin-like product may be stopped once at the end of the path and made to approach the reflex electronic sensor in a predetermined position. The stop-push mechanism can be appropriately established. In addition, a coin-like product may be stopped for measurement at an optional position, such as at the origin of and along the path. Moreover, a stage may be installed in the device to exclusively bring the reflex electronic sensor close to the both sides of a coin-like product. Such stage exclusively for detection is encompassed in the path for coin-like products, because the coin-like products enter and leave the stage.

The reflex electronic sensors to be disposed in such a manner that the both plate surfaces of a coin-like product can come in the proximity to the sensors do not need to be in an opposing relationship, and may be disposed in an unmatched manner, so that the centers will not synchronize. As a result, the two sides of a coin-like product approach the sensors in a staggered manner in terms of time.

The number of the reflex electronic sensors to be set is not limited to one pair, and plural sensors may be set to enhance the detection precision. While the total number of the reflex electronic sensors to be set is not limited, it is preferably multiples of one pair.

Since the coin-like product has a structure conventionally unavailable, identification thereof requires special determination criteria for the coin-like products.

When a coin-like product passes through the path, the reflex electronic sensors on the both sides provide outputs of the respective sides. When a coin-like product passes with two sides thereof facing the other way, the outputs of each sensor become different. To deal with this, one method is to set two output patterns as determination criteria, thereby enabling identification irrespective of the facing direction of the coin-like product.

The techniques for reflex electronic sensor (particularly reflex type magnetic sensor) itself, method of use and electrical • electrotechnological treatment techniques for handling output signals may be obtained by reference to known techniques, such as JP-B-2567654, JP-A-2000-11229 mentioned above and the like.

In a method for determining a coin-like product, for example, judgment is based on fulfillment of the above-mentioned condition (A). This determination method utilizes the fact that a true coin-like product always shows the same absolute value of the difference in the outputs provided by both reflex electronic sensors, irrespective of the facing direction of the product during passage through the path. According to this method, the outputs of the first layer and the second layer of a coin-like product are measured using a reflex electronic sensor, and the absolute value of the difference between them is retained as an acceptance value. The absolute value of the difference in the outputs provided by both reflex electronic sensors when an object in fact passed the path is compared with the acceptance value, and when the aforementioned absolute value is within the predetermined acceptance range relative to the acceptance value, an acceptance is output. This determination method uses only the range of relative difference in the outputs of the first layer and the second layer of a coin-like product. To be on the safe side, therefore, the absolute values of the outputs of respective layers may be compared to see if “the combination of the outputs of the first layer and the second layer” and “the combination of the measured outputs of the first layer and the second layer” are the same.

Now, examples of the arrangement of a reflex type electronic sensor and an identification method, when the coin-like product to be identified is a coin-like product of the above-mentioned (6) (i.e., a combination of a bi-metal structure and a laminate structure shown in FIG. 2) are given.

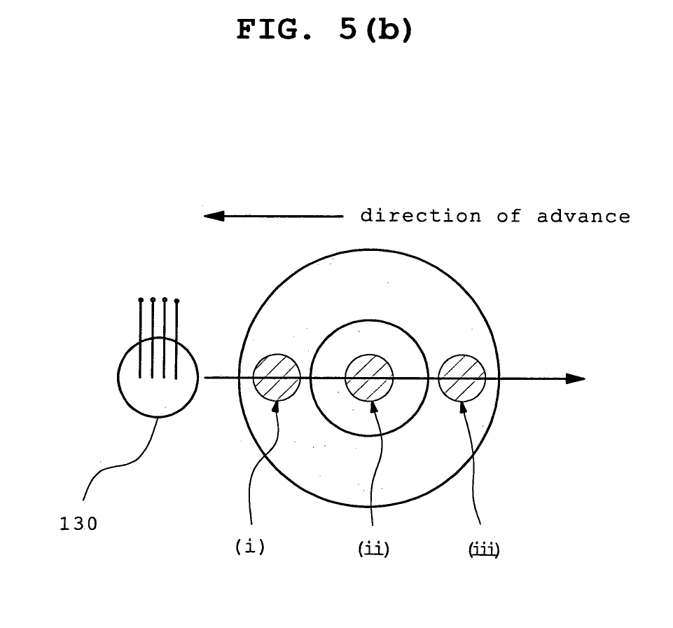

Examples of the basic arrangement of the reflex electronic sensor include an embodiment where reflex electronic sensors 100, 120, 200 and 220 are disposed along the path so that the sensors can come close to the central part and the peripheral part of each of the both surfaces of the coin-like product 1, as shown in FIG. 5(a). In this case, whether or not an object that passed through the path was a bi-metal structure (comparison of the center and periphery) is determined based on the outputs unique to the metallic materials of the central part 13 and the peripheral parts 21, 22 of the both surfaces, and whether or not one or both of the peripheral part and the central part is/are laminate structure(s) (comparison between front surfaces and between back surfaces) is determined based on the determination criteria obtained in advance as a correct combination.

In the embodiment of FIG. 5(a), exclusive reflex electronic sensors were disposed on the central part of the bi-metal structure and the peripheral part of the bi-metal structure. In the embodiment of FIG. 5(b), at least one pair of reflex electronic sensors (reflex type magnetic sensor 130 is drawn in the Figure) are disposed at the positions where the centers of both surfaces of a coin-like product pass, namely, at about half of the diameter of a coin-like product that passes the path. Due to this arrangement, peripheral part (i), central part (ii) and peripheral part (iii) approach the magnetic sensor 130 in this order, as the coin-like product moves in the direction of advance, showing an output specific to each part.

The judgment circuit for automatic identification of a coin-like product based on the output of a reflex electronic sensor may have a constitution to allow judgment by a circuit, by forming a logic circuit using electric circuits, electronic circuits and the like. Alternatively, output values and output waves may be converted to digital data, which are then input into a computer to allow for determination using a computer software.

### EFFECT OF THE INVENTION

As mentioned above, the structure of a coin-like product according to the present invention has different magnetic properties between the front and back surfaces with regard to identifiability by a reflex electronic sensor (particularly a reflex type magnetic sensor), which structure is not found heretofore. Therefore, provision of a coin-like product, an identification method thereof and an identification device thereof enhances the identifiability of coin-like products, which in turn dramatically broadens the range of choice of the design of an identification device.

The utility of the present invention becomes most notable when the coin-like product is a hard currency. Hard currencies require accurate identification because forged products must be excluded extremely strictly, and various kinds of coins are in simultaneous circulation, inclusive of expensive coins such as 500 yen coins. The unique constitution of the coin-like product of the present invention adds another clearly identifiable new factor to the conventional identification factors (outer shape, thickness, weight, special characteristic shape such as ridges etc., metallic material characteristics). As a result, identifiability of the coin is enhanced, and the range of design and choice of the detection device are broadened.

This application is based on a patent application No. 003648/2003 filed in Japan, the contents of which are hereby incorporated by reference.

What is claimed is:

1. A coin-like product having a laminate structure comprising two or more metal layers,
wherein said metal layers are laminated in a plate thickness direction of the coin-like product, and a first surface layer of the metal layer on one side of the coin-like product and a second surface layer on the other side of the coin-like product are composed of materials having different electric conductivities, which can be identified by a reflex electronic sensor.

2. The coin-like product of claim 1, wherein the material of the first layer and the material of the second layer are both non-magnetic metallic materials.

3. The coin-like product of claim 2, wherein the non-magnetic metallic material is copper or a copper alloy.

4. The coin-like product of claim 1, which has a dissimilar-metal-layout structure comprising at least one pair of parts made of different materials existing in the plate plane extending direction, wherein one or more of the parts has(have) said laminate structure.

5. The coin-like product of claim 4, wherein said parts are made of metal materials having different electric conductivities, which materials can be identified by a reflex electronic sensor.

6. The coin-like product of claim 4, wherein said dissimilar-metal-layout structure comprises different materials for a central part and a peripheral part of the plate.

7. The coin-like product of claim 6, wherein said parts are made of metal materials having different electric conductivities, which materials can be identified by a reflex electronic sensor.

8. The coin-like product of claim 1, wherein the reflex electronic sensor is a reflex type eddy current loss detection type magnetic sensor.

9. A method for identifying a coin-like product of any of claims 1 to 8, which method comprises the steps of
forming a path for the coin-like product to pass through,
disposing reflex electronic sensors along the path in such a manner that at least the first layer and the second layer of the coin-like product passing through the path come in the proximity to the sensors, and
judging whether or not an object that passed through the path is said coin-like product having the first layer and the second layer, based on the outputs of the reflex electronic sensors, which are specific to the metallic materials.

10. The method of claim 9, wherein the judgment is based on the following criteria (A):
(A) the absolute value of the difference between the outputs of the reflex electronic sensors on passage of the object through the path is within an admissible range relative to the absolute value of the difference between the outputs of the first layer and the second layer as measured in advance using said sensors.

11. The identification method of claim 9, wherein the coin-like product to be identified has the characteristics defined in claims 6 and 7, and the method comprises the steps of
setting reflex electronic sensors along the path in such a manner that the central part and the peripheral part of the both sides of the coin-like product come in the proximity to the sensors, and
judging whether or not the object that passed through the path has a dissimilar-metal-layout structure and whether or not at least one of the peripheral part and the central part is a laminate structure, based on the outputs specific to the metallic materials of the central part and the peripheral part of the both sides.

12. The identification method of claim 11, wherein at least one pair of the reflex electronic sensors are set at positions where the central parts of the both sides of the coin-like product pass, thereby to allow the product to successively come close to the sensors in the order of the peripheral part, the central part and the peripheral part.

13. The identification method of claim 9, wherein the reflex electronic sensor is a reflex type eddy current loss detection type magnetic sensor.

14. A device for identifying a coin-like product of any of claims 1 to 8, which comprises a path where the coin-like product can pass through, reflex electronic sensors along the path, which are disposed in such a manner that at least the first layer and the second layer of the coin-like product passing through the path come in the proximity to the sensors, and a judgment circuit to judge whether or not an object that passed through the path is said coin-like product having the first layer and the second layer, based on the output of each of the reflex electronic sensors, which is specific to the metallic material, and to output the judgment result.

15. The device of claim 14, wherein said path is adapted to move the coin-like product in the diameter direction and at least one pair of the reflex electronic sensors are disposed on the both sides of the path.

16. The device of claim 14, wherein the reflex electronic sensor is disposed at the position where the central part of the coin-like product passes.

17. The device of claim 16, wherein the coin-like product to be identified has the characteristics defined in claims 6 and 7, and the judgment circuit is so formed to judge whether or not an object that passed through the path is a coin-like product, based on the outputs specific to the metallic materials of the peripheral part, the central part and the peripheral part of the both sides of the object, which the sensors successively provide when the coin-like product passes through a detection area of said sensor.

18. The device of claim 14, wherein the reflex electronic sensor is a reflex type eddy current loss detection type magnetic sensor.
